(19) United States
(12) Patent Application Publication
(10) Pub. No.: US 2026/0341923 A1
(43) Pub. Date: Oct. 29, 2026

(54) ELECTRODE PLATE, CELL AND BATTERY MODULE

(71) Applicant: EVE POWER CO., LTD., Jingmen (CN)

(72) Inventors: Xin YANG, Jingmen (CN); Liquan CHEN, Jingmen (CN); Bin SU, Jingmen (CN); Zhengzhong LV, Jingmen (CN); Jian LI, Jingmen (CN); Chuankun ZHANG, Jingmen (CN); Juan LI, Jingmen (CN); Hougao XIONG, Jingmen (CN)

(73) Assignee: EVE POWER CO., LTD., Jingmen (CN)

(21) Appl. No.: 19/719,368

(22) Filed: Jun. 25, 2026

Related U.S. Application Data
(63) Continuation of application No. PCT/CN2024/122799, filed on Sep. 30, 2024.

(30) Foreign Application Priority Data
Apr. 30, 2024 (CN) 202420954961.5

(51) Int. Cl. H01M 50/533; H01M 10/04; H01M 50/204; H01M 50/502; H01M 50/528; H01M 50/538

(52) U.S. Cl. CPC H01M 50/533; H01M 10/0431; H01M 50/528; H01M 50/538; H01M 50/204; H01M 50/502

(57) ABSTRACT

An electrode plate, a cell and a battery module are provided. The electrode plate includes an electrode plate body and N tabs. The electrode plate body has a length direction and a width direction which are perpendicular to each other. The N tabs are arranged at intervals in the length direction of the electrode plate body, the bottom edge widths of the N tabs gradually decrease and then increase along the length direction of the electrode plate body, and the N tabs overlap after the electrode plate body is wound. N is a positive integer greater than or equal to 3.

### CROSS-REFERENCE TO RELATED APPLICATIONS

This application is a U.S. bypass continuation of International Patent Application No. PCT/CN2024/122799, filed on Sep. 30, 2024, which claims priority to Chinese Patent Application No. 202420954961.5, filed on Apr. 30, 2024. The entire contents of each of the above-referenced applications are expressly incorporated herein by reference.

### TECHNICAL FIELD

The present disclosure relates to the field of battery technology, and more particularly to an electrode plate, a cell and a battery module.

### BACKGROUND

Winding electrode plates to manufacture a battery is advantageous for increasing production speed and reducing production costs. To increase battery energy density, multi-tab electrode plates are often used for winding. In a process of winding multi-tab electrode plates, errors in dimensional accuracy of winding needle processing and errors in the thickness of the incoming electrode plate material may cause tab misalignment in a wound state. Severe misalignment may adversely affect subsequent ultrasonic soldering of the tabs to the adapters and cell assembly, which will increase defects during production, and compromise product performance.

In a multi-tab wound cell disclosed in related arts, the multiple tabs gradually decrease in width from the winding initial end to the winding tail end. After being wound, the tabs with progressively reduced widths can prevent adverse impact on the tab misalignment and thus improve alignment of the multiple tabs.

However, the above solution has the following drawbacks: due to the gradually decreasing tab widths, when there are many tabs, one or more tabs at the winding tail end may be too narrow. After the electrode plate is wound, the overlapping tabs must be ultrasonically soldered. The ultrasonic solder marks formed on the tabs must meet certain dimensional requirements to ensure solder stability and ampacity (the capacity of carrying current) at the tab locations. In the above solution, the width of the tab at the winding tail end may be less than the designed solder mark length, resulting in poor soldering which can seriously affect battery performance.

Therefore, an electrode plate, a cell and a battery module that can avoid this problem are in urgent demand.

### SUMMARY

In a first aspect, an electrode plate is provided according to the present application, which includes an electrode plate body and N tabs. The electrode plate body has a length direction and a width direction which are perpendicular to each other. The N tabs are arranged at intervals in the length direction of the electrode plate body, bottom edge widths of the N tabs decrease and then increase sequentially along the length direction of the electrode plate body, and the N tabs overlap after the electrode plate body is wound. N is a positive integer greater than or equal to 3.

In some embodiments, the N tabs include a middle tab and two end tabs located at two ends of the electrode plate respectively. In response to N being an odd number, an ((N+1)/2)^{th} tab is the middle tab. In response to N being an even number, an (N/2)^{th} tab and an ((N/2)+1)^{th} tab are the middle tabs. Among the N tabs, a bottom edge width of the middle tab is the smallest, and bottom edge widths of the two end tabs are the same.

In some embodiments, the bottom edge width of each end tab is a, and the bottom edge width of the middle tab is b, where b<a.

In response to N being the odd number, the bottom edge width difference Δw between two adjacent tabs is equal to 2(a−b)/(N−1).

In response to N being an even number, the bottom edge width difference Δw between the two middle tabs is equal to 0, and the bottom edge width difference Δw between non-middle tabs and the bottom edge width difference Δw between a non-middle tab and the middle tab are each equal to 2(a−b)/(N−2). The non-middle tab is a tab other than the middle tabs.

In some embodiments, the bottom edge width a of each end tab and the bottom edge width b of the middle tab satisfy: b≥a/2.

In some embodiments, the bottom edge width difference Δw between two adjacent tabs is in the range of 0 mm to 4 mm.

In some embodiments, each of the N tabs is provided with an ultrasonic solder mark, the N tabs are fixedly connected at the ultrasonic solder marks, the dimension of the ultrasonic solder mark in the length direction of the electrode plate body is L, and the bottom edge width of the tab with the smallest bottom edge width is 0.8 mm to 2 mm greater than L.

In some embodiments, heights of the N tabs are uniform.

Alternatively, the heights of the N tabs gradually increase along the length direction of the electrode plate body.

In some embodiments, the center-to-center distances between two adjacent tabs gradually increase along the length direction of the electrode plate body.

In some embodiments, the tab is trapezoidal, and a lower bottom edge of the tab is connected to the electrode plate body, and the bottom edge width is the width of the lower bottom edge of the tab.

In a second aspect, the present application provides a cell including a housing and a jelly roll component disposed within the housing. The jelly roll component includes a first separator, a positive electrode plate, a second separator, and a negative electrode plate stacked in sequence. The positive electrode plate and the negative electrode plate are the electrode plates described above.

In a third aspect, the present application provides a battery module including a cells contact system (CCS) assembly and multiple above-described cells. The CCS assembly is configured to collect voltage signals and temperature signals of the cells.

The electrode plate, the cell, and the battery module are provided according to this application. One end of the electrode plate body is fixed while the other end is wound to form a jelly roll. After winding, the N tabs overlap. The bottom edge widths of the N tabs decrease and then increase sequentially along the length direction of the electrode plate body. Among the N overlapping tabs, since adjacent tabs have different bottom edge widths, the tab with a smaller bottom edge width will fall within the area of the tab with a greater bottom edge width. Even if there is slight misalignment, the two side edges of the tab with a smaller bottom edge width generally do not extend beyond the two side edges of the tab with a greater bottom edge width. The design with width difference between adjacent tabs can offset misalignment caused by winding needle dimensional inaccuracy and electrode plate thickness inaccuracy. Furthermore, since the bottom edge widths of the N tabs decrease and then increase sequentially along the length direction of the electrode plate body, rather than in a trend of decreasing sequentially, the bottom edge width of the tab with the smallest bottom edge width is not excessively narrow, ensuring that the width of the tab meets ultrasonic soldering requirements, and ensuring solder strength and ampacity of the N tabs, and improving battery yield.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the disclosure.

FIG. 1 is a schematic structural diagram of an exemplary first electrode plate according to an embodiment of the present disclosure.

FIG. 2 is a schematic structural diagram of an exemplary second electrode plate according to an embodiment of the present disclosure.

FIG. 3 is a schematic diagram of an exemplary electrode plate wound into a jelly roll component according to an embodiment of the present disclosure.

FIG. 4 is a schematic sectional view of multiple exemplary electrode tabs in a height direction after the first electrode plate is wound according to an embodiment of the present application.

FIG. 5 is a schematic sectional view of multiple exemplary electrode tabs in a height direction after the second electrode plate is wound according to an embodiment of the present disclosure.

FIG. 6 is a schematic structural diagram of an exemplary battery module according to an embodiment of the present disclosure.

### REFERENCE NUMERALS

1 Electrode plate body; 2 tab; 100 jelly roll component; 200 cell; 300 CCS component.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented.

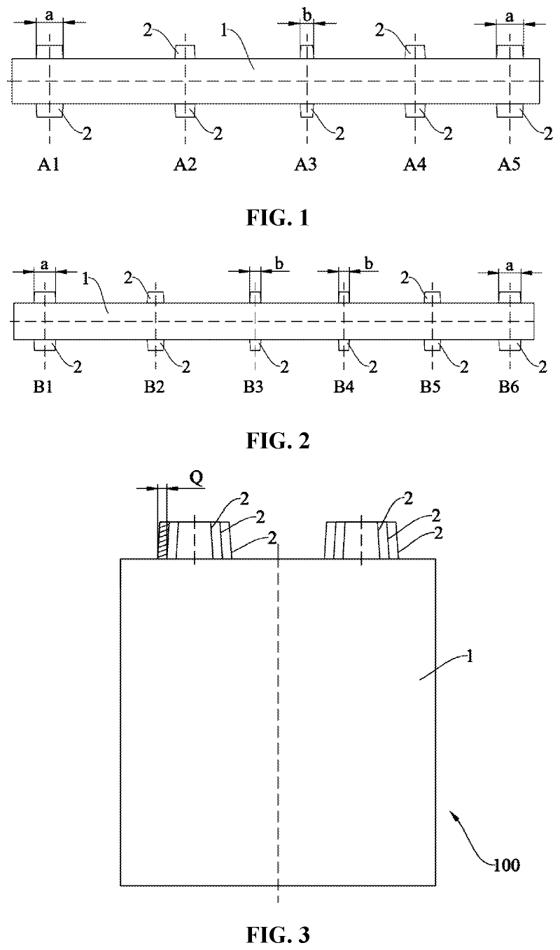

Referring to FIG. 1 and FIG. 2, an electrode plate is provided according to this embodiment, which may be, in some embodiments, a multi-tab electrode plate, including an electrode plate body 1 and N electrode tabs 2. This electrode plate not only reduces misalignment between the tabs 2 after a multi-tab electrode plate is wound, but also ensures that the bottom edge widths of the tabs 2 meet ultrasonic soldering requirements, thereby improving battery yield.

The electrode plate body 1 has a length direction and a width direction that are perpendicular to each other. Specifically, referring to FIG. 1 and FIG. 2, the left-right direction represents the length direction of the electrode plate body 1, and the up-down direction represents the width direction of the electrode plate body 1.

N tabs 2 are arranged at intervals in the length direction of the electrode plate body 1. Bottom edge widths of the N tabs 2 decrease and then increase sequentially along the length direction of the electrode plate body 1; and the N tabs 2 overlap after the electrode plate body 1 is wound. N is a positive integer greater than or equal to 3, such as 5, 6, 7, 8, and is selected based on battery design requirements.

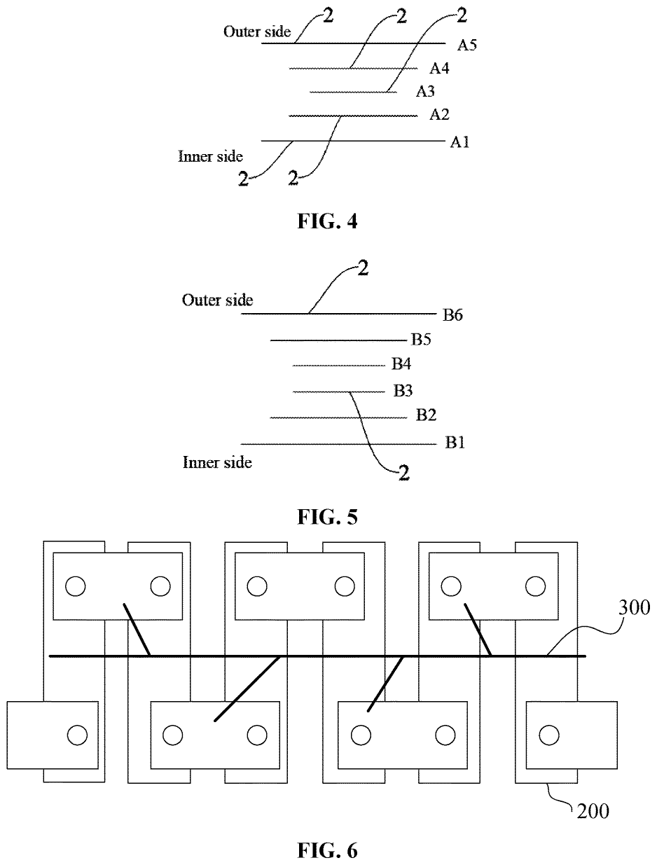

During the process of winding the electrode plate, one end of the electrode plate body 1 is fixed while the other end is wound to form a jelly roll. After winding, the N tabs 2 overlap, as shown in FIG. 3, FIG. 4, and FIG. 5. The N overlapping tabs 2 are ultrasonically soldered together and then electrically connected to the electrode terminal on a cell cover plate via an adapter. In this embodiment, the bottom edge widths of the N tabs 2 decrease and then increase along the length direction of the electrode plate body 1. Among the N overlapping tabs 2, since adjacent tabs 2 have different bottom edge widths, the tab 2 with a smaller bottom edge width will fall within the area of the tab 2 with a greater bottom edge width. Even if there is slight misalignment, the two side edges of the tab 2 with a smaller bottom edge width generally do not extend beyond the two side edges of the tab 2 with a greater bottom edge width. The design with a width difference between adjacent tabs 2 can offset misalignment caused by winding needle dimensional inaccuracy and electrode plate thickness inaccuracy. Furthermore, since the bottom edge widths of the N tabs 2 decrease and then increase along the length direction of the electrode plate body 1, rather than in a trend of decreasing sequentially, the bottom edge width of the tab 2 with the smallest bottom edge width is not excessively narrow, ensuring that the width of the tab 2 meets ultrasonic soldering requirements, ensuring solder strength and ampacity of the N tabs 2, and improving battery yield.

Referring to FIG. 1 and FIG. 2, an original electrode plate is cut by a cutting device to form multiple tabs 2. Furthermore, each of the two sides of the electrode plate body 1 in the width direction has N tabs 2, and the N tabs 2 on each side are arranged facing the N tabs 2 on the other side respectively. Referring to FIG. 1 and FIG. 2, before winding, the electrode plates are cut along the longitudinal centerline of each electrode plate to form two electrode plates, that is, upper and lower electrode plates, both of which can be used for winding. In some embodiments, the bottom edge widths of the two tabs 2 facing each other in the width direction are the same, which improves cutting efficiency.

The N tabs 2 include a middle tab and two end tabs at the two ends of the electrode plate. After the electrode plate body 1 is wound, the two end tabs are located on the outermost sides.

If N is an odd number, the ((N+1)/2)^{th} tab 2 is the middle tab, that is, the tab 2 in the middle is the middle tab. Referring to FIG. 1, in some embodiments, if N is 5, the third tab 2 is the middle tab, that is, the tab 2 at position A3 is the middle tab, and the number of tabs 2 on one side of the middle tab is the same as the number of tabs 2 on the other side. If N is 7, the fourth tab 2 is the middle tab, and so on.

If N is an even number, the (N/2)^{th} tab 2 and the ((N/2)+1)^{th} tab 2 are the middle tabs, that is, the two tabs 2 in the middle are the middle tabs. Referring to FIG. 2, in some embodiments, if N is 6, the third and fourth tabs 2 are the middle tabs, that is, the tabs 2 at positions B3 and B4 are the middle tabs, and the number of tabs 2 on each of the two sides of these two middle tabs is the same. If N is 8, the fourth and fifth tabs 2 are the middle tabs, and so on.

Among the N tabs 2 in this embodiment, the middle tab has the smallest bottom edge width. Specifically, referring to FIG. 1, the bottom edge width of the middle tab at position A3 is the smallest. Of the tabs 2 on two sides, the bottom edge width of the tab 2 at position A1 is greater than that at position A2, and the bottom edge width of the tab 2 at position A5 is greater than that at position A4. Specifically, referring to FIG. 2, the bottom edge widths of the middle tabs at positions B3 and B4 are the smallest. Of the tabs 2 on two sides, the bottom edge width of the tab 2 at position B1 is greater than that at position B2, and the bottom edge width of the tab 2 at position B6 is greater than that at position B5. Since the bottom edge width of the middle tab is the smallest, the bottom edge widths of the tabs 2 on the two sides increase from the center to the ends. This compensates for misalignments of the tabs 2 while ensuring the bottom edge width of the narrowest tab 2 to the maximum extent, preventing the bottom edge width of the narrowest tab 2 from being too narrow, thereby adversely affecting subsequent ultrasonic soldering.

A schematic diagram illustrating the overlapping of the five tabs 2 in FIG. 1 after the electrode plate body 1 is wound is as shown in FIG. 4. A schematic diagram illustrating the overlapping of the six tabs 2 in FIG. 2 after the electrode plate body 1 is wound is as shown in FIG. 5. The two narrowest middle tabs are located in the middle of the six tabs 2. The schematic sectional views of the multiple tabs in the height direction after the electrode plate body 1 is wound, as shown in FIG. 4 and FIG. 5, take it as an example that the left end of the electrode plate body 1 is fixed. Specifically, after winding, the tab A1 in FIG. 4 is located at the innermost side, and the tab A5 in FIG. 4 is located at the outermost side. The tab B1 in FIG. 5 is located at the innermost side, and the tab B6 in FIG. 5 is located at the outermost side.

In some embodiments, the bottom edge widths of the two end tabs are the same. That is, the bottom edge widths of the tabs 2 at positions A1 and A5 in FIG. 1 are the same, and the bottom edge widths of the tabs 2 at positions B1 and B6 in FIG. 2 are the same. Referring to FIG. 4 and FIG. 5, the two end tabs are located at the innermost and outermost sides, and the edges of the remaining tabs 2 do not extend beyond the edges of the two end tabs, ensuring uniformity after the multiple tabs 2 are stacked.

In some embodiments, except for the two adjacent middle tabs, the bottom edge width difference between adjacent tabs 2 is the same. In some embodiments, the bottom edge width of each end tab is a, and the bottom edge width of the middle tab is b, where b <a. If N is an odd number, the bottom edge width difference between adjacent tabs 2 is Δw=2(a−b)/(N−1).

Referring to FIG. 1, the bottom edge width of the tab 2 at position A3 is b, the bottom edge width of each of the tabs at positions A1 and A5 is a, and the bottom edge widths of the tabs at positions A2 and A4 are the same. N has a value of 5. The bottom edge width difference between two adjacent tabs 2 is Δw=(a−b)/2. The bottom edge width difference between the tabs 2 at positions A5 and A4 is equal to the bottom edge width difference between the tabs 2 at positions A4 and A3, and the bottom edge width difference between the tabs 2 at positions A1 and A2 is equal to the bottom edge width difference between the tabs 2 at positions A2 and A3.

If N is an even number, for the two middle tabs in the middle, the bottom edge width difference Δw=0. Except for these two middle tabs, the remaining tabs are non-middle tabs, and the bottom edge width difference Δw between non-middle tabs, as well as the bottom edge width difference Δw between middle and non-middle tabs, is 2(a−b)/(N−2).

Referring to FIG. 2, the bottom edge widths of the tabs 2 at positions B3 and B4 are b, the bottom edge widths of the tabs 2 at positions B1 and B6 are a, and the bottom edge widths of the tabs 2 at positions B2 and B5 are the same. N has a value of 6, and the bottom edge width difference Δw between two adjacent tabs 2 is 2(a−b)/(N−2). The bottom edge width difference between the tabs 2 at positions B6 and B5 is equal to the bottom edge width difference between the tabs 2 at positions B5 and B4, and the bottom edge width difference between the tabs 2 at positions B1 and B2 is equal to the bottom edge width difference between the tabs 2 at positions B2 and B3. (a −b) is the total width difference between the widest and narrowest tabs 2. In this embodiment, this total width difference is evenly distributed between adjacent tabs 2, ensuring that each adjacent tab 2 help reduce misalignments.

In some embodiments, the bottom edge width a of the end tab and the bottom edge width b of the middle tab satisfy the following condition: b≥a/2. This dimensional design minimizes the total width difference between the widest and narrowest tabs 2, which ensures that the narrowest tab 2 is not too narrow and reduces material consumption. In some embodiments, the bottom edge width b of the middle tab is equal to a/2; or the bottom edge width b of the middle tab is equal to a/3. In some embodiments, the bottom edge width a of the end tab is 6 mm, and the bottom edge width b of the middle tab is 3 mm.

In some embodiments, the bottom edge width difference Δw between two adjacent tabs 2 ranges from 0 mm to 4 mm. In some embodiments, Δw=0 only occurs when N is an even number. This bottom edge width difference Δw=0 specifically refers to the bottom edge width difference between the two middle tabs. For the bottom edge width difference between tabs when N is odd, the bottom edge width difference between non-middle tabs when N is even, and the bottom edge width difference between middle and non-middle tabs when N is even, Δw ranges from 0.1 mm to 4 mm. For example, the bottom edge width difference Δw is 0.1 mm, 0.5 mm, 1 mm, 1.5 mm, 2 mm, 2.5 mm, 3 mm, 3.5 mm, 4 mm, or the like. In this embodiment, Δw can be 2 mm, 3 mm, or 4 mm to ensure sufficient misalignment tolerance between adjacent tabs 2 and avoid wasting a large amount of material for tabs 2.

Referring to FIG. 3, for adjacent tabs 2 with a non-zero bottom edge width difference, the degree of misalignment at each of the left and right sides of the narrower tab 2 is defined as a misalignment margin Q, where Q=Δw/2. That is, the allowable misalignment at each of the left and right edges of the narrower tab 2 is Δw/2. When the centerlines of two adjacent tabs 2 coincide, the distance between the edge of the narrower tab 2 and the edge of the wider tab 2 is exactly Δw/2. The misalignment margin Q ranges from 0.05 mm to 2 mm. In some embodiments, the value of the misalignment margin Q may be 0.05 mm, 0.5 mm, 1 mm, 1.5 mm, and 2 mm, ensuring sufficient misalignment tolerance between adjacent tabs 2 and effectively offsetting misalignment of tabs 2 caused by the dimensional inaccuracy of the winding needle and the thickness inaccuracy of the electrode plate.

N tabs 2 are subsequently joined together using an ultrasonic soldering process. After the ultrasonic soldering head stamps, the ultrasonic solder mark is formed on each of the N tabs 2, so that the N tabs 2 are fixedly connected at the ultrasonic solder marks. The ultrasonic solder marks of the tabs 2 require a specific size range during design to ensure the stability and the ampacity of the tabs 2 after the ultrasonic connection. In this embodiment, the dimension of the ultrasonic solder mark in the length direction of the electrode plate body 1 is L. The bottom edge width of the tab 2 with the narrowest bottom edge width is 0.8 mm to 2 mm greater than L. Specifically, referring to FIG. 1 and FIG. 2, the bottom edge width b of the middle tab is 0.8 mm to 2 mm greater than the designed length L of the ultrasonic solder mark; in some embodiments, 0.8 mm, 1 mm, 1.2 mm, 1.4 mm, 1.6 mm, 1.8 mm, or 2 mm greater than L. This ensures that each tab 2 has a complete ultrasonic solder mark, ensuring the connection strength of the tabs 2 after ultrasonic soldering and the ampacity of the tabs 2 after being assembled into the cell 200, thereby improving the performance of the battery product.

In some embodiments, the bottom edge width b of the middle tab is 1 mm greater than the designed length L of the ultrasonic solder mark. This ensures that each tab 2 has a complete ultrasonic solder mark while starting material usage is minimized.

In some embodiments, referring to FIG. 1 and FIG. 2, the N tabs 2 have the same height so that the top edges of the N tabs 2, after winding, are as flush as possible.

In some embodiments, the height of the N tabs 2 may gradually increase along the length direction of the electrode plate body 1. After the electrode plate body 1 is wound, the top portions of the N tabs 2 can be cut off to ensure that the tops of the N overlapping tabs 2 are flusher.

In this embodiment, the center-to-center distance between adjacent tabs 2 gradually increases along the length direction of the electrode plate body 1, ensuring that the N tabs 2 overlap in the process of winding. One end of the electrode plate body 1 serves as the winding insertion end (which is fixed), and the other end serves as the winding end segment. In the direction from the winding insertion end to the winding end segment, the center-to-center distances between adjacent tabs 2 gradually increase to ensure that the N tabs 2 overlap after winding. That is, the end with a smaller center-to-center distance serves as the winding insertion end.

Referring to FIG. 1 and FIG. 2, the tab 2 is trapezoidal in shape, with its lower bottom edge connected to the electrode plate body 1. This strengthens the base of the tab 2 and prevents breakage of the tab 2 due to strain. In some embodiments, the tab 2 is an isosceles trapezoid, ensuring uniform strength at the base of both sides of the tab 2 and maintaining the quality of the tab 2 after winding and overlapping, thereby improving the ampacity of the tab 2.

A cell 200 is further provided according to this embodiment and includes a housing and a jelly roll component 100 disposed within the housing. The jelly roll component 100 includes a first separator, a positive electrode plate, a second separator, and a negative electrode plate which are stacked in sequence. Both the positive electrode plate and the negative electrode plate are embodied as the electrode plate described above. In some embodiments, a third separator and a packaging film are stacked on the side of the negative electrode plate facing away from the second separator, and are wound together to form the jelly roll component 100. FIG. 3 is a sectional view of the jelly roll component 100. The multiple overlapping tabs 2 on the left side are formed by winding with the positive electrode plate, and the multiple overlapping tabs 2 on the right side are formed by winding with the negative electrode plate. This jelly roll component 100 eliminates misalignment of the tabs 2, ensuring that both the N tabs 2 of the positive electrode plate and the N tabs 2 of the negative electrode plate meet subsequent ultrasonic soldering requirements, thereby improving the performance of the cell 200.

The housing of the cell 200 includes a container and a cover plate. The cover plate is provided with positive and negative electrode terminals. N overlapping tabs 2 are soldered to the corresponding electrode terminals via adapters.

FIG. 6 is a schematic structural diagram of a battery module according to an embodiment of the present application. Referring to FIG. 6, a battery module is further provided according to this embodiment, which includes multiple cells 200 as described above. The battery module further includes a cells contact system (CCS) assembly 300 configured to collect voltage and temperature signals from the cells 200. The battery module with the cells 200 described above can be assembled smoothly and has excellent performance.

What is claimed is:

1. An electrode plate, comprising:
an electrode plate body having a length direction and a width direction perpendicular to each other; and
N tabs arranged at intervals in the length direction of the electrode plate body, wherein bottom edge widths of the N tabs decrease and then increase sequentially along the length direction of the electrode plate body, and the N tabs overlap after the electrode plate body is wound,
wherein N is a positive integer greater than or equal to 3.

2. The electrode plate according to claim 1, wherein the N tabs comprise a middle tab and two end tabs located at opposite ends of the sequence of N tabs,
wherein in response to N being an odd number, an ((N+1)/2)^{th} tab is the middle tab,
wherein in response to N being an even number, an (N/2)^{th} tab and an ((N/2)+1)^{th} tab are middle tabs, and
wherein among the N tabs, a bottom edge width of the middle tab is the smallest, and bottom edge widths of the two end tabs are the same.

3. The electrode plate according to claim 2, wherein each of the bottom edge widths of the two end tabs is a, and the bottom edge width of the middle tab is b, wherein b<a,
wherein in response to N being the odd number, a bottom edge width difference Δw between two adjacent tabs of the N tabs is equal to 2(a−b)/(N−1),
wherein in response to N being the even number, a bottom edge width difference Δw between the two middle tabs is equal to 0, and each of a bottom edge width difference Δw between non-middle tabs and a bottom edge width difference Δw between a non-middle tab and a middle tab is equal to 2(a−b)/(N−2), wherein the non-middle tab is a tab other than the middle tabs among the N tabs.

4. The electrode plate according to claim 3, wherein each of the bottom edge widths a of the two end tabs and the bottom edge width b of the middle tab satisfy: b≥a/2.

5. The electrode plate according to claim 1, wherein a bottom edge width difference Δw between two adjacent tabs of the N tabs is in a range of 0 mm to 4 mm.

6. The electrode plate according to claim 1, wherein each of the N tabs is provided with an ultrasonic solder mark, the N tabs are each fixedly connected at the ultrasonic solder mark, a dimension of the ultrasonic solder mark in the length direction of the electrode plate body is L, and a bottom edge width of a tab with a smallest bottom edge width among the N tabs is 0.8 mm to 2 mm greater than L.

7. The electrode plate according to claim 1, wherein
heights of the N tabs are uniform; or heights of the N tabs gradually increase along the length direction of the electrode plate body.

8. The electrode plate according to claim 1, wherein center-to-center distances between two adjacent tabs of the N tabs gradually increase along the length direction of the electrode plate body.

9. The electrode plate according to claim 1, wherein each of the N tabs are trapezoidal, and lower bottom edges of the N tabs are connected to the electrode plate body, and the bottom edge widths are widths of the lower bottom edges of the N tabs.

10. A cell, comprising:
a housing; and
a jelly roll component disposed within the housing,
wherein the jelly roll component comprises a first separator, a positive electrode plate, a second separator, and a negative electrode plate which are stacked in sequence, and each of the positive electrode plate and the negative electrode plate comprises an electrode plate body having a length direction and a width direction perpendicular to each other, and N tabs arranged at intervals in the length direction of the electrode plate body, wherein bottom edge widths of the N tabs decrease and then increase sequentially along the length direction of the electrode plate body, and the N tabs overlap after the electrode plate body is wound,
wherein N is a positive integer greater than or equal to 3.

11. The cell according to claim 10, wherein the N tabs comprise a middle tab and two end tabs located at two ends of the electrode plate respectively,
wherein in response to N being an odd number, an ((N+1)/2)^{th} tab is the middle tab,
wherein in response to N being an even number, an (N/2)^{th} tab and an ((N/2)+1)^{th} tab are middle tabs, and
wherein among the N tabs, a bottom edge width of the middle tab is the smallest, and bottom edge widths of the two end tabs are the same.

12. The cell according to claim 11, wherein each of the bottom edge widths of the two end tabs is a, and the bottom edge width of the middle tab is b, and b<a,
wherein in response to N being the odd number, a bottom edge width difference Δw between two adjacent tabs of the N tabs is equal to 2(a−b)/(N−1),
wherein in response to N being the even number, a bottom edge width difference Δw between the two middle tabs is equal to 0, and each of a bottom edge width difference Δw between non-middle tabs and a bottom edge width difference Δw between a non-middle tab and a middle tab is equal to 2(a−b)/(N−2), wherein the non-middle tab is a tab other than the middle tabs among the N tabs.

13. The cell according to claim 12, wherein each of the bottom edge widths of the two end tabs a and the bottom edge width of the middle tab b satisfy: b≥a/2.

14. The cell according to claim 10, wherein a bottom edge width difference Δw between two adjacent tabs of the N tabs is in a range of 0 mm to 4 mm.

15. The cell according to claim 10, wherein each of the N tabs is provided with an ultrasonic solder mark, the N tabs are each fixedly connected at the ultrasonic solder mark, a dimension of the ultrasonic solder mark in the length direction of the electrode plate body is L, and a bottom edge width of a tab with a smallest bottom edge width among the N tabs is 0.8 mm to 2 mm greater than L.

16. The cell according to claim 10, wherein heights of the N tabs are uniform or increase gradually along the length direction of the electrode plate body.

17. The cell according to claim 10, wherein center-to-center distances between two adjacent tabs of the N tabs gradually increase along the length direction of the electrode plate body.

18. The cell according to claim 10, wherein the N tabs are trapezoidal, and lower bottom edges of the N tab are connected to the electrode plate body, and the bottom edge widths are widths of the lower bottom edges of the N tabs.

19. A battery module, comprising:
a cells contact system (CCS) assembly; and
a plurality of cells,
wherein the CCS assembly is configured to collect voltage signals and temperature signals of the plurality of cells, and a cell of the plurality of cells comprises a housing and a jelly roll component disposed within the housing, wherein the jelly roll component comprises a first separator, a positive electrode plate, a second separator, and a negative electrode plate which are stacked in sequence, and each of the positive electrode plate and the negative electrode plate comprises an electrode plate body having a length direction and a width direction perpendicular to each other, and N tabs arranged at intervals in the length direction of the electrode plate body, wherein bottom edge widths of the N tabs decrease and then increase sequentially along the length direction of the electrode plate body, and the N tabs overlap after the electrode plate body is wound, wherein N is a positive integer greater than or equal to 3.

20. The battery module according to claim 19, wherein the N tabs comprise a middle tab and two end tabs located at two ends of the electrode plate respectively,
wherein in response to N being an odd number, an ((N+1)/2)^{th} tab is the middle tab,
wherein in response to N being an even number, an (N/2)^{th} tab and an ((N/2)+1)^{th} tab are middle tabs, and
wherein among the N tabs, a bottom edge width of the middle tab is the smallest, and bottom edge widths of the two end tabs are the same.
